(19) United States
(12) Patent Application Publication
(10) Pub. No.: US 2022/0101674 A1
(43) Pub. Date: Mar. 31, 2022

(54) TRAVELER CONTROL SYSTEM

(71) Applicant: MICHINOKU SHIGENKAIHATSU CO., LTD., Hachinohe-shi, Aomori (JP)

(72) Inventor: Junichi TSUKIDATE, HACHINOHE-SHI, AOMORI (JP)

(21) Appl. No.: 17/430,830

(22) PCT Filed: Oct. 21, 2020
(86) PCT No.: PCT/JP2020/039599

§ 371 Date: Aug. 13, 2021

(30) Foreign Application Priority Data
May 27, 2020 (JP) 2020-091967

(51) Int. Cl. G07C 9/20; G06Q 50/26

(52) U.S. Cl. CPC G07C 9/20; G06Q 50/265

(57) ABSTRACT

A traveler control system includes: a recording medium carried by a traveler, the recording medium configured to store certification information of not having a pathogen (CIONHAP) which proves that the traveler does not have a particular pathogen and expiration time information (ETI) of the CIONHAP; an information recording apparatus managed by an administrator of CIONHAP who has authority to issue the CIONHAP and ETI thereof, the information recording apparatus configured to store the CIONHAP and the ETI of the CIONHAP in the recording medium; and a gate apparatus configured to, when the traveler is passing the gate apparatus, acquire as input the CIONHAP and ETI of the CIONHAP from the recording medium, and allow the traveler to pass the gate apparatus only if the presence of the CIONHAP is confirmed and expiration time indicated by the ETI of the CIONHAP has not passed yet when the information is input.

### TECHNICAL FIELD

The present invention relates to a traveler control system. More specifically, the present invention relates to a traveler control system for preventing the spread of a particular pathogen by travelers.

### BACKGROUND ART

For example, a conventional gate system and a method of controlling thereof described in Patent Literature 1 is known. The gate system comprises “an information recording medium (4) configured to store predetermined information, a gate apparatus (1) configured to allow a traveler to pass the gate apparatus or prevent the traveler from passing the gate apparatus by checking the information recording medium, a weight sensor (5) provided on the floor of the entrance portion of the gate apparatus (4), and a determination and control unit (10) configured to determine whether an actual weight value of the traveler measured by the weight sensor is within a predetermined deviation from a declared weight value of the allowed traveler previously stored in and read from the information recording medium when the traveler presents the medium, and to allow the traveler to pass the gate apparatus only if the actual weight value is within the predetermined deviation from the declared weight value” (see the summary of Patent Literature 1).

According to this related art, “it is possible using a simple configuration to prevent unauthorized entrance and exit when an unauthorized traveler uses a legitimate information recording medium fraudulently or multiple travelers ‘piggyback,’ i.e., pass the gate apparatus simultaneously with one legitimate information recording medium” (see the summary of Patent Literature 1).

The related art, however, cannot prevent the spread of a particular pathogen by travelers.

### CITATION LIST

### Patent Literature

Patent Literature 1

Japanese Patent Laid-Open No. 5-26719

### SUMMARY OF INVENTION

### Technical Problem

The object of the present invention is to provide a traveler control system that can prevent the spread of a particular pathogen by travelers.

### Solution to Problem

In order to solve the problem described above, the present invention provides a traveler control system including:

a recording medium carried by a traveler, the recording medium configured to store certification information of not having a pathogen which proves that the traveler does not have a particular pathogen and expiration time information of the certification information of not having the pathogen;

an information recording apparatus managed by an administrator of certification information of not having the pathogen who has authority to issue the certification information of not having the pathogen and the expiration time information thereof, the information recording apparatus configured to store the certification information of not having the pathogen and the expiration time information of the certification information of not having the pathogen in the recording medium; and

a gate apparatus configured to, when the traveler is passing the gate apparatus, acquire as input the certification information of not having the pathogen and the expiration time information of the certification information of not having the pathogen from the recording medium carried by the traveler, allow the traveler to pass the gate apparatus if the presence of the certification information of not having the pathogen is confirmed and expiration time indicated by the expiration time information of the certification information of not having the pathogen has not passed yet when the certification information of not having the pathogen or the expiration time information of the certification information of not having the pathogen is input, and prevent the traveler from passing the gate apparatus if the presence of the certification information of not having the pathogen is not confirmed or expiration time indicated by the expiration time information of the certification information of not having the pathogen has already passed when the information is input.

This traveler control system can be used as follows and make desirable effects accordingly.
(1)

The administrator of certification information of not having the pathogen, who has authority to issue the certification information of not having the pathogen and the expiration time information thereof, stores the certification information of not having the pathogen and the expiration time information the certification information of not having the pathogen in the recording medium by the information recording apparatus managed by the administrator.
(2)

The traveler carries the recording medium while the traveler is traveling.
(3)

The gate apparatus is installed at the entrance of a site or area in which the spread of a particular pathogen by the traveler should be prevented.
(4)

When the traveler is passing the gate apparatus to enter the site or area beyond the gate apparatus, the gate apparatus acquires as input the certification information of not having the pathogen and the expiration time information of the certification information of not having the pathogen from the recording medium carried by the traveler, allows the traveler to pass the gate apparatus if the presence of the certification information of not having the pathogen is confirmed and expiration time indicated by the expiration time information of the certification information of not having the pathogen has not passed yet when the information is input, and prevents the traveler from passing the gate apparatus if the presence of the certification information of not having the pathogen is not confirmed or expiration time indicated by the expiration time information of the certification information of not having the pathogen has already passed when the information is input.

That is, the gate apparatus allows the traveler to pass the gate apparatus only if the traveler has the recording medium, the presence of the certification information of not having the pathogen is confirmed, and expiration time indicated by the expiration time information of the certification information of not having the pathogen has not passed yet when the information is input.

Thus, permission to enter the site or area through the gate apparatus is given only to those who are recognized to be clean from the particular pathogen, even if not completely, by the administrator of certification information of not having the pathogen who has authority to issue the certification information of not having the pathogen and the expiration time information thereof, which prevents the spread of the particular pathogen by the traveler.

In this way, this traveler control system can prevent the spread of the particular pathogen by the traveler.

In order to solve the problem described above, the present invention also provides a traveler control system including:

a recording medium carried by a traveler, the recording medium configured to store certification information of vaccination which proves that the traveler has received a particular vaccine and expiration time information of the certification information of vaccination;

an information recording apparatus managed by an administrator of certification information of vaccination who has authority to issue the certification information of vaccination and the expiration time information thereof, the information recording apparatus configured to store the certification information of vaccination and the expiration time information of the certification information of vaccination in the recording medium; and

a gate apparatus configured to, when the traveler is passing the gate apparatus, acquire as input the certification information of vaccination and the expiration time information of the certification information of vaccination from the recording medium carried by the traveler, allow the traveler to pass the gate apparatus if the presence of the certification information of vaccination is confirmed and expiration time indicated by the expiration time information of the certification information of vaccination has not passed yet when the information is input, and prevent the traveler from passing the gate apparatus if the presence of the certification information of vaccination is not confirmed or expiration time indicated by the expiration time information of the certification information of vaccination has already passed when the certification information of vaccination or the expiration time information thereof is input.

This traveler control system can be used as follows and make desirable effects accordingly.
(1)

The administrator of certification information of vaccination, who has authority to issue the certification information of vaccination and the expiration time information thereof, stores the certification information of vaccination and the expiration time information of the certification information of vaccination in the recording medium by the information recording apparatus managed by the administrator.
(2)

The traveler carries the recording medium while the traveler is traveling.
(3)

The gate apparatus is installed at the entrance of a site or area in which the spread of a particular pathogen by the traveler should be prevented.
(4)

When the traveler is passing the gate apparatus to enter the site or area beyond the gate apparatus, the gate apparatus acquires as input the certification information of vaccination and the expiration time information of the certification information of vaccination from the recording medium carried by the traveler, allows the traveler to pass the gate apparatus if the presence of the certification information of vaccination is confirmed and expiration time indicated by the expiration time information of the certification information has not passed yet when the information is input, and prevents the traveler from passing the gate apparatus if the presence of the certification information of vaccination is not confirmed or expiration time indicated by the expiration time information of the certification information of vaccination has already passed when the information is input.

That is, the gate apparatus allows the traveler to pass the gate apparatus only if the traveler has the recording medium, the presence of the certification information of vaccination is confirmed, and expiration time indicated by the expiration time information of the certification information of the vaccination has not passed yet when the information is input.

Thus, permission to enter the site or area through the gate apparatus is given only to those who are recognized to be clean from the particular pathogen, even if not completely, by the administrator of certification information of vaccination who has authority to issue the certification information of vaccination of vaccination and the expiration time information thereof, which prevents the spread of the particular pathogen by the traveler.

In this way, this traveler control system can prevent the spread of the particular pathogen by the traveler.

In order to solve the problem described above, the present invention also provides a traveler control system including:

a recording medium carried by a traveler, the recording medium configured to store traveler identification information that identifies the traveler;

recording means configured to store, in relation to the traveler identification information, certification information of not having a pathogen which proves that the traveler does not have a particular pathogen and expiration time information of the certification information of not having the pathogen;

an information recording apparatus managed by an administrator of certification information of not having the pathogen who has authority to issue the certification information of not having the pathogen and the expiration time information thereof, the information recording apparatus configured to store the certification information of not having the pathogen and the expiration time information of the certification information of not having the pathogen in the recording means in relation to the traveler identification information; and

a gate apparatus configured to, when the traveler is passing the gate apparatus, acquire as input the traveler identification information from the recording medium carried by the traveler, check the traveler identification information against the certification information of not having the pathogen and the expiration time information of the certification information of not having the pathogen that correspond to the traveler identification information and are stored in the recording means, allow the traveler to pass the gate apparatus if the presence of the certification information of not having the pathogen is confirmed and expiration time indicated by the expiration time information of the certification information of not having the pathogen has not passed yet when the traveler identification information is input, and prevent the traveler from passing the gate apparatus if the presence of the certification information of not having the pathogen is not confirmed or expiration time indicated by the expiration time information of the certification information of not having the pathogen has already passed when the traveler identification information is input.

This traveler control system can be used as follows and make desirable effects accordingly.
(1)

Traveler identification information that identifies the traveler is stored in the recording medium carried by the traveler.
(2)

The administrator of certification information of not having a pathogen, who has authority to issue the certification information of not having the pathogen and the expiration time information thereof, stores the certification information of not having the pathogen and the expiration time information of the certification information of not having the pathogen in the recording means in relation to the traveler identification information by the information recording apparatus managed by the administrator.
(3)

The traveler carries the recording medium while the traveler is traveling.
(4)

The gate apparatus is installed at the entrance of a site or area in which the spread of a particular pathogen by the traveler should be prevented.
(5)

When the traveler is passing the gate apparatus to enter the site or area beyond the gate apparatus, the gate apparatus acquires as input the traveler identification information from the recording medium carried by the traveler, checks the traveler identification information against the certification information of not having the pathogen and the expiration time information of the certification information of not having the pathogen that correspond to the traveler identification information and are stored in the recording means, allows the traveler to pass the gate apparatus if the presence of the certification information of not having the pathogen is confirmed and expiration time indicated by the expiration time information of the certification information of not having the pathogen has not passed yet when the traveler identification information is input, and prevents the traveler from passing the gate apparatus if the presence of the certification information of not having the pathogen is not confirmed or expiration time indicated by the expiration time information of the certification information of not having the pathogen has already passed when the traveler identification information is input.

That is, the gate apparatus allows the traveler to pass the gate apparatus only if the traveler has the recording medium, the presence of the certification information of not having the pathogen corresponding to the traveler identification information of the traveler is confirmed, and expiration time indicated by the expiration time information of the certification information of not having the pathogen has not passed yet when the information is input.

Thus, permission to enter the site or area through the gate apparatus is given only to those who are recognized to be clean from the particular pathogen, even if not completely, by the administrator of certification information of not having the pathogen who has authority to issue the certification information of not having the pathogen and the expiration time information thereof, which prevents the spread of the particular pathogen by the traveler.

In this way, this traveler control system can prevent the spread of the particular pathogen by the traveler.

In order to solve the problem described above, the present invention also provides a traveler control system including:

a recording medium carried by a traveler, the recording medium configured to store traveler identification information that identifies the traveler;

recording means configured to store, in relation to the traveler identification information, certification information of vaccination which proves that the traveler has received a particular vaccine and expiration time information of the certification information of vaccination;

an information recording apparatus managed by an administrator of certification information of vaccination who has authority to issue the certification information of vaccination and the expiration time information thereof, the information recording apparatus configured to store the certification information of vaccination and the expiration time information of the certification information of vaccination in the recording means in relation to the traveler identification information; and

a gate apparatus configured to, when the traveler is passing the gate apparatus, acquire as input the traveler identification information from the recording medium carried by the traveler, check the traveler identification information against the certification information of vaccination and the expiration time information of the certification information of vaccination that correspond to the traveler identification information and are stored in the recording means, allow the traveler to pass the gate apparatus if the presence of the certification information of vaccination is confirmed and expiration time indicated by the expiration time information of the certification information of the vaccination has not passed yet when the traveler identification information is input, and prevent the traveler from passing the gate apparatus if the presence of the certification information of vaccination is not confirmed or expiration time indicated by the expiration time information of the certification information of vaccination has already passed when the traveler identification information is input.

This traveler control system can be used as follows and make desirable effects accordingly.
(1)

Traveler identification information that identifies the traveler is stored in the recording medium carried by the traveler.
(2)

The administrator of certification information of vaccination, who has authority to issue the certification information of vaccination and the expiration time information thereof, stores the certification information of vaccination and the expiration time information of the certification information of vaccination in the recording means in relation to the traveler identification information by the information recording apparatus managed by the administrator.
(3)

The traveler carries the recording medium while the traveler is traveling.
(4)

The gate apparatus is installed at the entrance of a site or area in which the spread of a particular pathogen by the traveler should be prevented.
(5)

When the traveler is passing the gate apparatus to enter the site or area beyond the gate apparatus, the gate apparatus acquires as input the traveler identification information from the recording medium carried by the traveler, checks the traveler identification information against the certification information of vaccination and the expiration time information of the certification information of vaccination that correspond to the traveler identification information and are stored in the recording means, allows the traveler to pass the gate apparatus if the presence of the certification information of vaccination is confirmed and expiration time indicated by the expiration time information of the certification information of vaccination has not passed yet when the traveler identification information is input, and prevents the traveler from passing the gate apparatus if the presence of the certification information of vaccination is not confirmed or expiration time indicated by the expiration time information of the certification information of vaccination has already passed when the traveler identification information is input.

That is, the gate apparatus allows the traveler to pass the gate apparatus only if the traveler has the recording medium, the presence of the certification information of vaccination corresponding to the traveler identification information is confirmed, and expiration time indicated by the expiration time information of the certification information of vaccination has not passed yet when the information is input.

Thus, permission to enter the site or area through the gate apparatus is given only to those who are recognized to be clean from the particular pathogen, even if not completely, by the administrator of certification information of vaccination who has authority to issue the certification information of vaccination and the expiration time information thereof, which prevents the spread of the particular pathogen by the traveler.

In this way, this traveler control system can prevent the spread of the particular pathogen by the traveler.

In the traveler control system described above, the recording medium may be a passport.

In this case, travelers do not need to carry a recording medium separate and aside from their passport.

### BRIEF DESCRIPTION OF DRAWINGS

FIG. 1 is a system block diagram illustrating an embodiment of a traveler control system according to the invention.

FIG. 2 is a system block diagram illustrating another embodiment.

FIG. 3 is a system block diagram illustrating yet another embodiment.

FIG. 4 is a system block diagram illustrating still another embodiment.

FIG. 5 is a block diagram illustrating a case where a non-contact IC card is used as a recording medium 10.

FIG. 6 is a schematic diagram illustrating exemplary data stored in the recording medium 10.

FIG. 7 is a block diagram of a control unit 34.

FIG. 8 is a flowchart of the control unit 34.

FIG. 9 is a diagram illustrating the appearance of a card-type recording medium 10.

FIG. 10(a) is a block diagram of a confirmation apparatus 50.

FIG. 10(b) is a flowchart of the confirmation apparatus 50.

### DESCRIPTION OF EMBODIMENTS

Traveler control systems according to the present invention will now be described in reference to the drawings. Like reference signs designate identical or corresponding parts throughout the drawings.

### First Embodiment

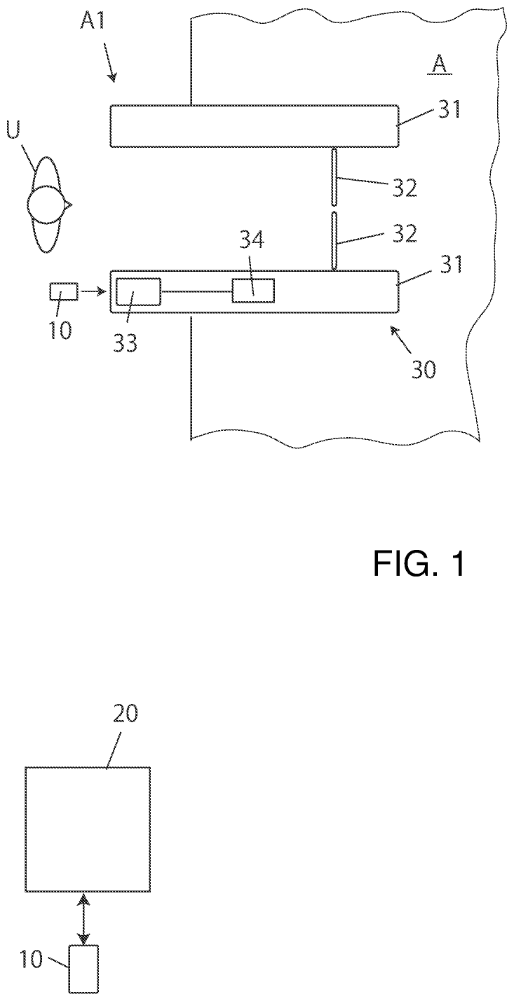

As shown in FIG. 1, a traveler control system according to the present embodiment includes:

a recording medium 10 carried by a traveler U, the recording medium 10 configured to store certification information of not having a pathogen which proves that the traveler U does not have a particular pathogen and expiration time information of the certification information of not having the pathogen;

an information recording apparatus 20 managed by an administrator of certification information of not having the pathogen who has authority to issue the certification information of not having the pathogen and the expiration time information thereof, the information recording apparatus 20 configured to store the certification information of not having the pathogen and the expiration time information of the certification information of not having the pathogen in the recording medium 10; and

a gate apparatus 30 configured to, when the traveler U is passing the gate apparatus 30, acquire as input the certification information of not having the pathogen and the expiration time information of the certification information of not having the pathogen from the recording medium 10 carried by the traveler U, allow the traveler U to pass the gate apparatus 30 if the presence of the certification information of not having the pathogen is confirmed and expiration time indicated by the expiration time information of the certification information of the certification information of not having the pathogen has not passed yet when the certification information of not having the pathogen or the expiration time information of the certification information of not having the pathogen is input, and prevent the traveler U from passing the gate apparatus 30 if the presence of the certification information of not having the pathogen is not confirmed or expiration time indicated by the expiration time information of the certification information of not having the pathogen has already passed when the information is input.

A “pathogen,” as used herein, refers to a protozoan, bacterium or virus that causes a disease.

A “particular pathogen” may be selected by a user of this system. The particular pathogen may be Zika fever, malaria, Ebola hemorrhagic fever, avian influenza, measles or the new coronavirus (SARS-CoV-2).

This traveler control system can be used as follows and make desirable effects accordingly.

(1)

The administrator of certification information of not having the pathogen, who has authority to issue the certification information of not having the pathogen and the expiration time information thereof, stores the certification information of not having the pathogen and the expiration time information of the certification information of not having the pathogen in the recording medium 10 by the information recording apparatus 20 managed by the administrator.

(2)

The traveler U carries the recording medium 10 while the traveler U is traveling.

(3)

The gate apparatus 30 is installed at the entrance A1 of a site or area A in which the spread of the particular pathogen by the traveler U should be prevented. For example, the gate apparatus 30 may be installed as a gate for a public transportation system.

(4)

When the traveler U is passing the gate apparatus 30 to enter the site or area A beyond the gate apparatus 30, the gate apparatus 30 acquires as input the certification information of not having the pathogen and the expiration time information thereof from the recording medium 10 carried by the traveler U, allows the traveler U to pass the gate apparatus 30 if the presence of the certification information of not having the pathogen is confirmed and expiration time indicated by the expiration time information of the certification information of not having the pathogen has not passed yet when the information (the certification information of not having the pathogen or the expiration time information of the certification information of not having the pathogen) is input, and prevents the traveler U from passing the gate apparatus 30 if the presence of the certification information of not having the pathogen is not confirmed or expiration time indicated by the expiration time information of the certification information of not having the pathogen has already passed when the information is input.

That is, the gate apparatus 30 allows the traveler U to pass the gate apparatus 30 only if the traveler U carries the recording medium 10, the presence of the certification information of not having the pathogen is confirmed, and expiration time indicated by the expiration time information of the certification information of not having the pathogen has not passed yet when the information is input to the gate apparatus 30.

Thus, permission to enter the site or area A through the gate apparatus 30 is given only to people (travelers) recognized to be clean from the particular pathogen, even if not completely, by the administrator of certification information of not having the pathogen who has authority to issue the certification information of not having the pathogen and the expiration time information thereof, which prevents the spread of the particular pathogen by the traveler U.

In this way, this traveler control system can prevent the spread of the particular pathogen by the traveler U.

### Second Embodiment

Hardware used to implement this embodiment may be the same as that used to implement the previous embodiment, and therefore a traveler control system according to the present embodiment will also be described in reference to FIG. 1. The traveler control system includes:

a recording medium 10 carried by a traveler U, the recording medium 10 configured to store certification information of vaccination which proves that the traveler U has received a particular vaccine and expiration time information of the certification information of vaccination;

an information recording apparatus 20 managed by an administrator of certification information of vaccination who has authority to issue the certification information of vaccination and the expiration time information thereof, the information recording apparatus 20 configured to store the certification information of vaccination and the expiration time information of the certification information of not having the pathogen in the recording medium 10; and

a gate apparatus 30 configured to, when the traveler U is passing the gate apparatus 30, acquire as input the information of vaccination and the expiration time information of the certification information of not having the pathogen from the recording medium 10 carried by the traveler U, allow the traveler U to pass the gate apparatus 30 if the presence of the certification information of vaccination is confirmed and expiration time indicated by the expiration time information of the certification information of vaccination has not passed yet when the certification information of vaccination or the expiration time information of the certification information of vaccination is input, and prevent the traveler U from passing the gate apparatus 30 if the presence of the certification information of vaccination is not confirmed or expiration time indicated by the expiration time information of the certification information of vaccination has already passed when the information is input.

A “vaccine,” as used herein, refers to a medicine for preventing an infectious disease.

A “particular vaccine” may be selected by a user of this system. The particular vaccine may be a vaccine for preventing infection with Zika fever, malaria, Ebola hemorrhagic fever, avian influenza, measles or the new coronavirus (SARS-CoV-2). The particular vaccine may also be a vaccine for a pathogen such as a virus that will arise in the future.

This traveler control system can be used as follows and make desirable effects accordingly.
(1)

The administrator of certification information of vaccination, who has authority to issue the certification information of vaccination and the expiration time information thereof, stores the certification information of vaccination and the expiration time information of the certification information of vaccination in the recording medium 10 by the information recording apparatus 20 managed by the administrator.
(2)

The traveler U carries the recording medium 10 while the traveler U is traveling.
(3)

The gate apparatus 30 is provided at the entrance A1 of a site or area A in which the spread of the particular pathogen by the traveler U should be prevented.
(4)

When the traveler U is passing the gate apparatus 30 to enter the site or area A beyond the gate apparatus 30, the gate apparatus 30 acquires as input the certification information of vaccination and the expiration time information of the certification information of vaccination from the recording medium 10 carried by the traveler U, allows the traveler U to pass the gate apparatus 30 if the presence of the certification information of vaccination is confirmed and expiration time indicated by the expiration time information of the certification information of vaccination has not passed yet when the certification information of vaccination or the expiration time information of the certification information of vaccination is input, and prevents the traveler U from passing the gate apparatus 30 if the presence of the certification information of vaccination is not confirmed or expiration time indicated by the expiration time information of the certification information of vaccination has already passed when the information is input.

That is, the gate apparatus 30 allows the traveler to pass the gate apparatus 30 only if the traveler U has the recording medium 10, the presence of the certification information of vaccination is confirmed, and expiration time indicated by the expiration time information of the certification information of vaccination has not passed yet when the information is input.

Thus, permission to enter the site or area A through the gate apparatus 30 is given only to those who are recognized to be clean from the particular pathogen, even if not completely, by the administrator of certification information of vaccination who has authority to issue the certification information of vaccination and the expiration time information thereof, which prevents the spread of the particular pathogen by the traveler U.

In this way, this traveler control system can prevent the spread of the particular pathogen by the traveler U.

### Third Embodiment

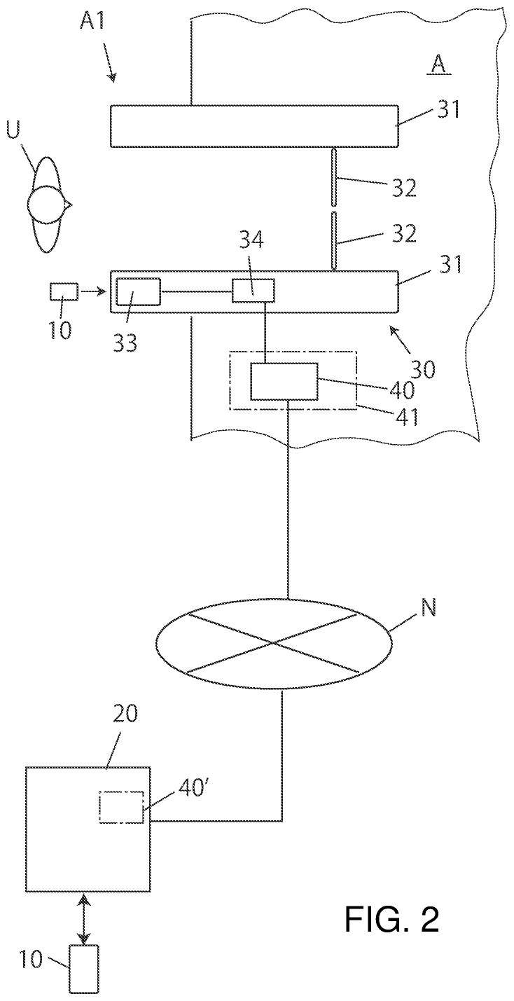

As shown in FIG. 2, a traveler control system according to the present embodiment includes:

a recording medium 10 carried by a traveler U, the recording medium 10 configured to store traveler identification information that identifies the traveler U;

recording means 40 configured to store, in relation to the traveler identification information, certification information of not having a pathogen which proves that the traveler U does not have a particular pathogen and expiration time information of the certification information of not having the pathogen;

an information recording apparatus 20 managed by an administrator of certification information of not having the pathogen who has authority to issue the certification information of not having the pathogen and the expiration time information thereof, the information recording apparatus 20 configured to store the certification information of not having the pathogen and the expiration time information of the certification information of not having the pathogen in the recording means 40 in relation to the traveler identification information; and

a gate apparatus 30 configured to, when the traveler U is passing the gate apparatus 30, acquire as input the traveler identification information from the recording medium 10 carried by the traveler U, check the traveler identification information against the certification information of not having the pathogen and the expiration time information of the certification information of not having the pathogen that correspond to the traveler identification information and are stored in the recording means 40, allow the traveler U to pass the gate apparatus 30 if the presence of the certification information of not having the pathogen is confirmed and expiration time indicated by the expiration time information of the certification information of not having the pathogen has not passed yet when the traveler identification information is input, and prevent the traveler U from passing the gate apparatus 30 if the presence of the certification information of not having the pathogen is not confirmed or expiration time indicated by the expiration time information of the certification information of not having the pathogen has already passed when the traveler identification information is input.

This traveler control system can be used as follows and make desirable effects accordingly.
(1)

Traveler identification information that identifies the traveler U is stored in the recording medium 10 carried by the traveler U.
(2)

The administrator of certification information of not having the pathogen, who has authority to issue the certification information of not having the pathogen and the expiration time information thereof, stores the certification information of not having the pathogen and the expiration time information of the certification information of not having the pathogen in the recording means 40 in relation to the traveler identification information by the information recording apparatus 20 managed by the administrator.
(3)

The traveler U carries the recording medium 10 while the traveler U is traveling.
(4)

The gate apparatus 30 is installed at the entrance A1 of a site or area A in which the spread of the particular pathogen by the traveler U should be prevented.
(5)

When the traveler U is passing the gate apparatus 30 to enter the site or area A beyond the gate apparatus 30, the gate apparatus 30 acquires as input the traveler identification information from the recording medium 10 carried by the traveler U, checks the traveler identification information against the certification information of not having the pathogen and the expiration time information of the certification information of not having the pathogen that correspond to the traveler identification information and are stored in the recording means 40, allows the traveler U to pass the gate apparatus 30 if the presence of the certification information of not having the pathogen is confirmed and expiration time indicated by the expiration time information of the certification information of not having the pathogen has not passed yet when the traveler identification information is input, and prevents the traveler U from passing the gate apparatus 30 if the presence of the certification information of not having the pathogen is not confirmed or expiration time indicated by the expiration time information of the certification information of not having the pathogen has already passed when the traveler identification information is input.

That is, the gate apparatus 30 allows the traveler U to pass the gate apparatus 30 only if the traveler U carries the recording medium 10, the presence of the certification information of not having the pathogen corresponding to the traveler identification information of the traveler U is confirmed, and expiration time indicated by the expiration time information of the certification information of not having the pathogen has not passed yet when the traveler identification information is input.

Thus, permission to enter the site or area A through the gate apparatus 30 is given only to those who are recognized to be clean from the particular pathogen, even if not completely, by the administrator of certification information of not having the pathogen who has authority to issue the certification information of not having the pathogen and the expiration time information thereof, which prevents the spread of the particular pathogen by the traveler U.

In this way, this traveler control system can prevent the spread of the particular pathogen by the traveler U.

### Fourth Embodiment

Hardware used to implement this embodiment may be the same as that used to implement the previous embodiment (FIG. 2), and therefore a traveler control system according to the present embodiment will also be described in reference to FIG. 2. The traveler control system includes:

a recording medium 10 carried by a traveler U, the recording medium 10 configured to store traveler identification information that identifies the traveler U;

recording means 40 configured to store, in relation to the traveler identification information, certification information of vaccination which proves that the traveler U has received a particular vaccine and expiration time information of the certification information of vaccination;

an information recording apparatus 20 managed by an administrator of certification information of vaccination who has authority to issue the certification information of vaccination and the expiration time information thereof, the information recording apparatus 20 configured to store the certification information of vaccination and the expiration time information of the certification information of vaccination in the recording means 40 in relation to the traveler identification information; and

a gate apparatus 30 configured to, when the traveler U is passing the gate apparatus 30, acquire as input the traveler identification information from the recording medium 10 carried by the traveler U, check the traveler identification information against the certification information of vaccination and the expiration time information of the certification information of vaccination that correspond to the traveler identification information and are stored in the recording means 40, allow the traveler U to pass the gate apparatus 30 if the presence of the certification information of vaccination is confirmed and expiration time indicated by the expiration time information of the certification information of vaccination has not passed yet when the traveler identification information is input, and prevent the traveler U from passing the gate apparatus 30 if the presence of the certification information of vaccination is not confirmed or expiration time indicated by the expiration time information of the certification information of vaccination has already passed when the traveler identification information is input.

This traveler control system can be used as follows and make desirable effects accordingly.
(1)

Traveler identification information that identifies the traveler U is stored in the recording medium 10 carried by the traveler U.
(2)

The administrator of certification information of vaccination, who has authority to issue the certification information of vaccination and the expiration time information thereof, stores the certification information of vaccination and the expiration time information of the certification information of vaccination in the recording means 40 in relation to the traveler identification information by the information recording apparatus 20 managed by the administrator.
(3)

The traveler U carries the recording medium 10 while the traveler U is traveling.
(4)

The gate apparatus 30 is installed at the entrance A1 of a site or area A in which the spread of the particular pathogen by the traveler U should be prevented.
(5)

When the traveler U is passing the gate apparatus 30 to enter the site or area A beyond the gate apparatus 30, the gate apparatus 30 acquires as input the traveler identification information from the recording medium 10 carried by the traveler U, checks the traveler identification information against the certification information of vaccination and the expiration time information of the certification information of vaccination that correspond to the traveler identification information and are stored in the recording means 40, allows the traveler U to pass the gate apparatus 30 if the presence of the certification information of vaccination is confirmed and expiration time indicated by the expiration time information of the certification information of vaccination has not passed yet when the traveler identification information is input to the gate apparatus 30, and prevents the traveler U from passing the gate apparatus 30 if the presence of the certification information of vaccination is not confirmed or expiration time indicated by the expiration time information of the certification information of vaccination has already passed when the traveler identification information is input to the gate apparatus 30.

That is, the gate apparatus 30 allows the traveler U to pass the gate apparatus 30 only if the traveler U has the recording medium 10, the presence of the certification information of vaccination corresponding to the traveler identification information of the traveler U is confirmed, and expiration time indicated by the expiration time information of the certification information has not passed yet when the traveler identification information is input to the gate apparatus 30.

Thus, permission to enter the site or area A through the gate apparatus 30 is given only to those who are recognized to be clean from the particular pathogen, even if not completely, by the administrator of certification information of vaccination who has authority to issue the certification information of vaccination and the expiration time information thereof, which prevents the spread of the particular pathogen by the traveler U.

In this way, this traveler control system can prevent the spread of the particular pathogen by the traveler U.

In the traveler control system described above, the recording medium 10 may be a passport.

In this case, travelers do not need to carry a recording medium separate and aside from their passport.

<First Implementation of Recording Medium>

A recording medium 10 according to a first implementation is carried by a traveler U and stores certification information of not having a pathogen which proves that the traveler U does not have a particular pathogen and expiration time information of the certification information of not having the pathogen,

the certification information of not having the pathogen and the expiration time information of the certification information of not having the pathogen are stored by an information recording apparatus 20 that is managed by an administrator of certification information of not having the pathogen who has authority to issue the certification information of not having the pathogen and the expiration time information thereof.

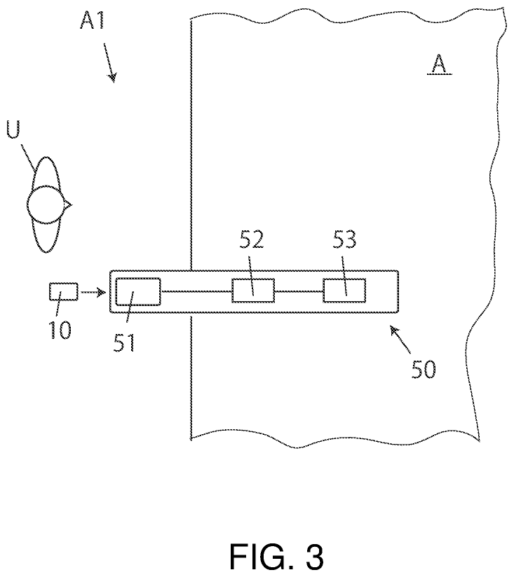

This recording medium 10 can be used for the above-mentioned traveler control systems. In addition, as shown in FIG. 3, the recording medium 10 can also be used to determine whether to allow the traveler U to enter a site or area A in which the spread of the particular pathogen by the traveler U should be prevented by providing, at the entrance A1 of the site or area A, a confirmation apparatus 50 that acquires as input the certification information of not having the pathogen and the expiration time information of the certification information of not having the pathogen from the recording medium 10 carried by the traveler U and confirms the presence of the certification information of not having the pathogen.

<Second Implementation of Recording Medium>

A recording medium 10 according to a second implementation is carried by a traveler U and store certification information of vaccination which proves that the traveler U has received a particular vaccine and expiration time information of the certification information of vaccination,

the certification information of vaccination and the expiration time information of the certification information of vaccination stored by an information recording apparatus 20 that is managed by an administrator of certification information of vaccination who has authority to issue the certification information of vaccination and the expiration time information thereof.

This recording medium 10 can be used for the above-mentioned traveler control systems. In addition, as shown in FIG. 3, the recording medium 10 can also be used to determine whether to allow the traveler U to enter a site or area A in which the spread of the particular pathogen by the traveler U should be prevented by providing, at the entrance A1 of the site or area A, a confirmation apparatus 50 that acquires as input the certification information of vaccination and the expiration time information of certification information of vaccination from the recording medium 10 carried by the traveler U and confirms the presence of the certification information of vaccination.

The recording medium 10 may further store medical information of the traveler U such as the blood type, information on medications being taken, and current and historical disease information.

Configuring in this manner makes it easier for a medical institution to treat the traveler U if the traveler U is sent to the medical institution as a patient.

In particular, the recording medium 10 makes it easier to determine whether the traveler U has an infection or not so that the traveler U can be accepted and treated more smoothly.

In the following, a more detailed description is provided.

The recording medium 10 may be any recording medium that can store traveler identification information that identifies the traveler U carrying the recording medium 10, certification information of not having a pathogen which proves that the traveler U does not have a particular pathogen and expiration time information of the certification information of not having the pathogen, and/or certification information of vaccination and expiration time information of the certification information of vaccination. For example, the recording medium 10 may be a contact IC card, a non-contact IC card or a portable terminal device such as a smartphone (hereinafter simply referred to as a smartphone).

IC cards can be categorized into contract IC cards and non-contact IC cards. A contact IC card has a module terminal that contacts with a reader/writer terminal of a card terminal device and communicates with the card terminal device with the module terminal in direct contact with the reader/writer terminal.

A non-contact IC card incorporates an antenna and exchanges data wirelessly with a terminal device when the card is placed in a magnetic field generated by a reader/writer of the terminal device.

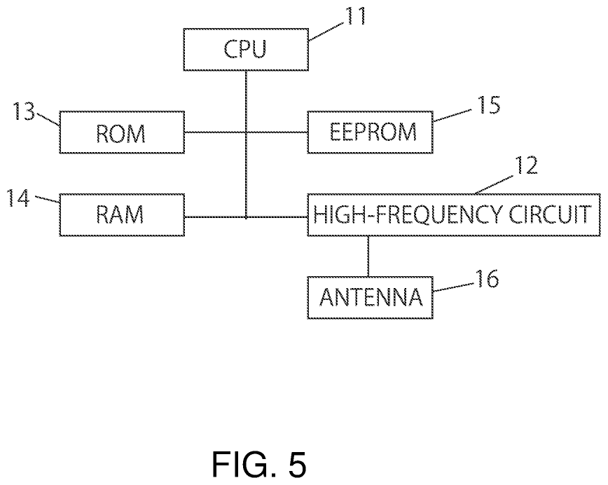

FIG. 5 is a block diagram illustrating an exemplary hardware configuration of a non-contact IC card that can be used as the recording medium 10.

This non-contact IC card (10) includes a central processing unit (CPU) 11, a high-frequency circuit 12, a read only memory (ROM) 13, a random access memory (RAM) 14, an electrically erasable and programmable ROM (EEPROM) 15 and an antenna 16.

The elements except the antenna 16 are implemented in an IC chip incorporated in the non-contact IC card. The antenna 16 extends in an internal periphery of the non-contact IC card and the ends of the antenna 16 are connected to the IC chip.

If a smartphone is used as the recording medium 10, the functions of the above elements and antenna can be implemented by elements and an antenna of the smartphone.

The CPU 11 is a central processing unit that performs information processing according to programs stored in the ROM 13 and the EEPROM 15. The CPU 11 communicates with a gate apparatus 30 or a confirmation apparatus 50 via a reader/writer and retrieves and transmits required information from among information stored in the recording medium 10 to the gate apparatus 30 or the confirmation apparatus 50.

The high-frequency circuit 12 converts a high-frequency transmitted by a reader/writer to the antenna 16 to a digital signal and outputs the resulting digital signal to the CPU 11, and converts a digital signal output by the CPU 11 to a high-frequency and outputs the resulting high-frequency to the antenna 16, which in turn transmits the high-frequency to the reader/writer.

The RAM 14 is a random read and write memory that serves as a working memory for information processing performed by the CPU 11.

The ROM 13 is a read only memory that stores basic programs, parameters and data to operate the non-contact IC card properly.

The EEPROM 15 is a ROM to which information can be written and from which information can be erased. Information stored in the EEPROM 15 is maintained without power supply to the non-contact IC card.

The ROM 13 and the EEPROM 15 provide a program/data storage area for the non-contact IC card.

For example, the EEPROM 15 stores an operating system (OS), which is a basic program to operate the non-contact IC card properly, and application programs.

The EEPROM 15 also stores specific information, i.e., information that is different for and specific to each non-contact IC card.

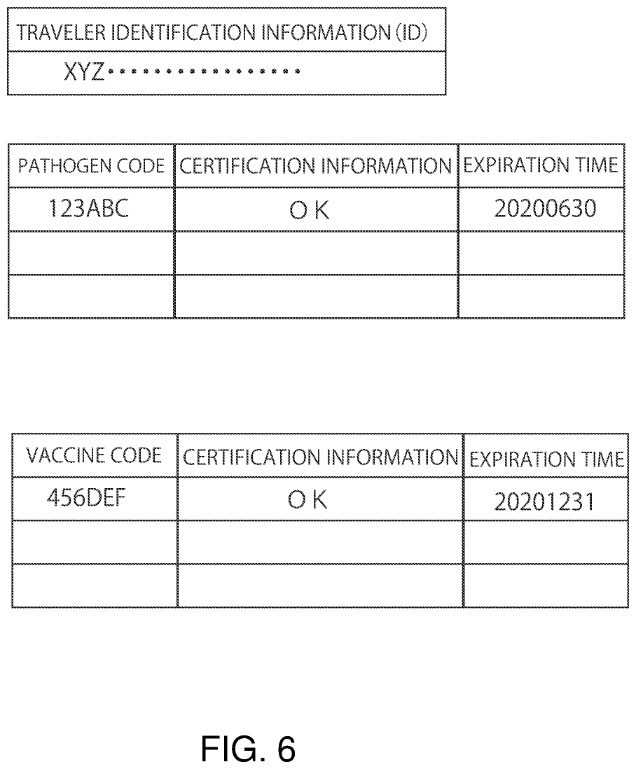

FIG. 6 is a schematic diagram illustrating exemplary data stored in the EEPROM 15.

The EEPROM 15 stores traveler identification information (ID) that identifies the traveler U carrying the recording medium 10, certification information of not having a pathogen which proves that the traveler U does not have a particular pathogen and expiration time information of the certification information of not having the pathogen, and certification information of vaccination and expiration time information of the certification information of vaccination.

For example, as shown in FIG. 6, the traveler identification information (ID) is stored in the form of an alphanumeric character string having a predetermined length, the name of the pathogen is stored in the form of a code having a predetermined length (“123ABC” in FIG. 6), the certification information for the pathogen is stored in the form of a predetermined code (“OK” in FIG. 6), and the expiration time of the certification information is stored in the form of year-month-day (“20200630” in FIG. 6). Moreover, the name of the vaccine is stored in the form of a code having a predetermined length (“456DEF” in FIG. 6), the certification information for the vaccine is stored in the form of a predetermined code (“OK” in FIG. 6), and the expiration time of the certification information is stored in the form of year-month-day (“202001231” in FIG. 6).

In FIG. 6, the certification information of not having a pathogen which proves that the traveler U does not have the particular pathogen includes a pathogen code and its corresponding certification information (“OK”). That is, it is proven (“OK”) that this traveler U does not have a pathogen designated by the pathogen code (“123ABC”) and this certification is valid until Jun. 30, 2020.

Similarly, the certification information of vaccination includes a vaccine code and its corresponding certification information (“OK”). That is, it is proven (“OK”) that this traveler U has received a vaccine designated by the vaccine code (“456DEF”) and this certification is valid until Dec. 31, 2020.

The certification information of not having a pathogen and the expiration time information of the certification information of not having a pathogen, the certification information of vaccination and the expiration time information of the certification information of vaccination are stored in the recording medium 10 by an information recording apparatus 20 that is managed by an administrator of certification information who has authority to issue such certification information and expiration time information.

If a passport is used as the recording medium 10, the passport has to be an IC passport and the above-mentioned elements are implemented in an IC embedded in the passport.

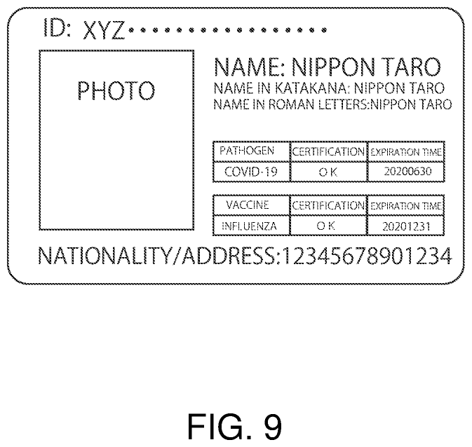

If the recording medium 10 is a card-type medium, the recording medium 10 may have an appearance as shown in FIG. 9.

If a smartphone is used as the recording medium 10, a similar image as shown in FIG. 9 may be displayed on the display screen of the smartphone.

In the nationality/address field, the first three digits (123) may be a country code, the next two digits (45) may be a prefecture code, the following two digits (67) may be a city code, the subsequent two digits (89) may be a town code, the succeeding two digits (01) may be an area code, and the last three digits (234) may be a block code.

The administrator of the information recording apparatus 20 may be a medical institute that is given authority to issue the certification information and the expiration time information thereof by a national government.

The information recording apparatus 20 (see FIG. 2) may be a personal computer that can write the various kinds of information described above to the recording medium 10. More specifically, the information recording apparatus 20 includes an input device such as a keyboard and a mouse, an output device such as a display, a reader/writer that is capable of near-field communication with a non-contact IC card, and an IC card communication module that can transmit and receive data and commands to and from a non-contact IC card via the reader/writer.

The gate apparatus 30 may be a flap-type gate apparatus as shown in FIG. 1.

The gate apparatus 30 includes left and right side walls 31, 31 that form a pathway, doors 32, 32 that are attached to the side walls so as to block the pathway, an information reading unit 33 provided on one of the side walls 31, 31 to read information stored in the recording medium 10 carried by the traveler U, and a control unit 34 that processes the information read by the information reading unit 33 from the recording medium 10, determines whether to allow the traveler U to pass the gate apparatus 30, and controls the doors 32, 32 to open or close according to the determination.

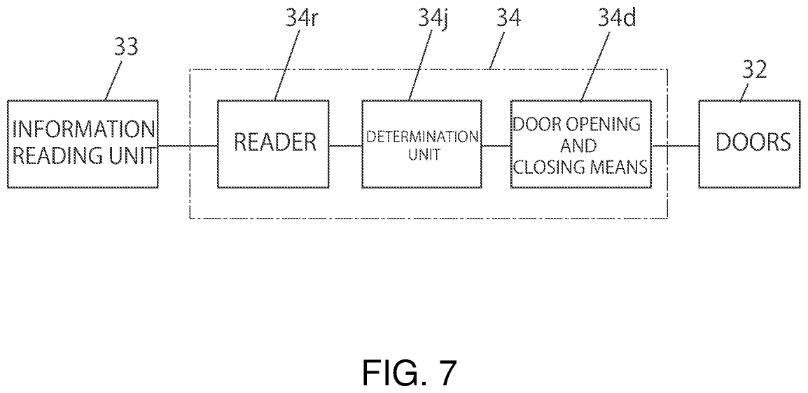

As shown in the block diagram of FIG. 7, the control unit 34 includes a reader 34r that reads information stored in the recording medium 10 presented at the information reading unit 33 and converts the read information to a signal, a determination unit 34j that determines whether to allow the traveler U to pass the gate apparatus 30 or not based on the stored information read by the reader 34r and transmits a control signal to door opening and closing means 34d according to the determination, and driving means 34d that drives the door 32, 32 to open or close according to the control signal from the determination unit 34j.

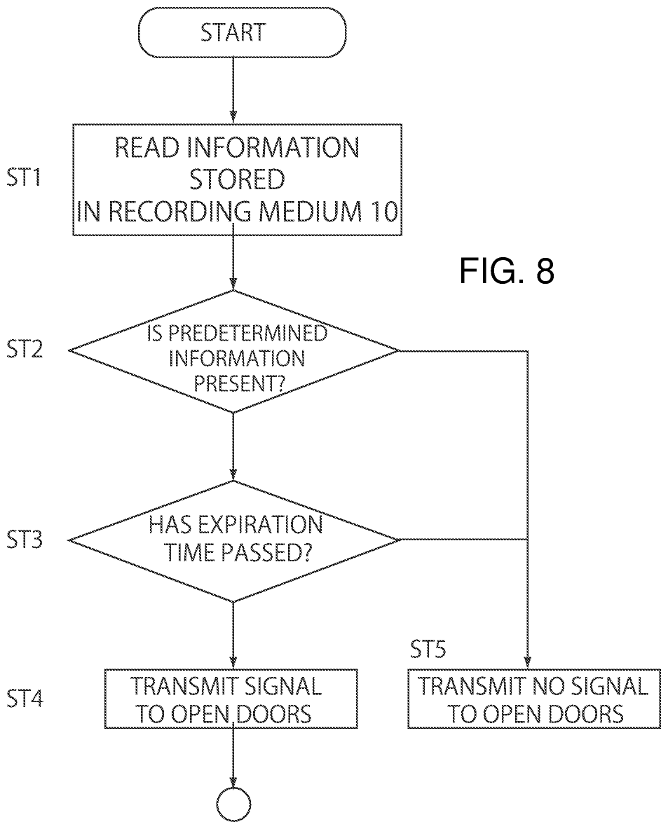

FIG. 8 is a flowchart illustrating operation of the determination unit 34j.

The determination unit 34j operates as follows:

### <Step ST1>

Read information stored in the recording medium 10.

### <Step ST2>

Determine the presence or absence of certification information of not having a particular pathogen for which entry control is implemented (a pathogen code and its corresponding certification information (“OK”)) and/or certification information of vaccination (a vaccine code and its corresponding certification information (“OK”)) and expiration time information of the certification information.

If the above information is present, the determination unit 34j proceeds to Step ST3. Otherwise, if the above information is absent, the determination unit 34j proceeds to Step STS.

### <Step ST3>

Determine whether or not expiration time of the above information has passed when the information is read in Step ST1.

If expiration time of the above information has not passed yet when the information is read in Step ST1, the determination unit 34j proceeds to Step ST4. Otherwise, the determination unit 34j proceeds to Step ST5. <Step ST4>

Transmit a control signal to open the doors 32, 32 to the driving means 34d.

### <Step ST5>

Transmit no control signal to open the doors 32, 32 to the driving means 34d (keep the doors 32, 32 closed).

The gate apparatus 30 may be located at a ticket gate in a station, in an area where boarding procedures are performed in an airport, or at the entrance of a sport stadium.

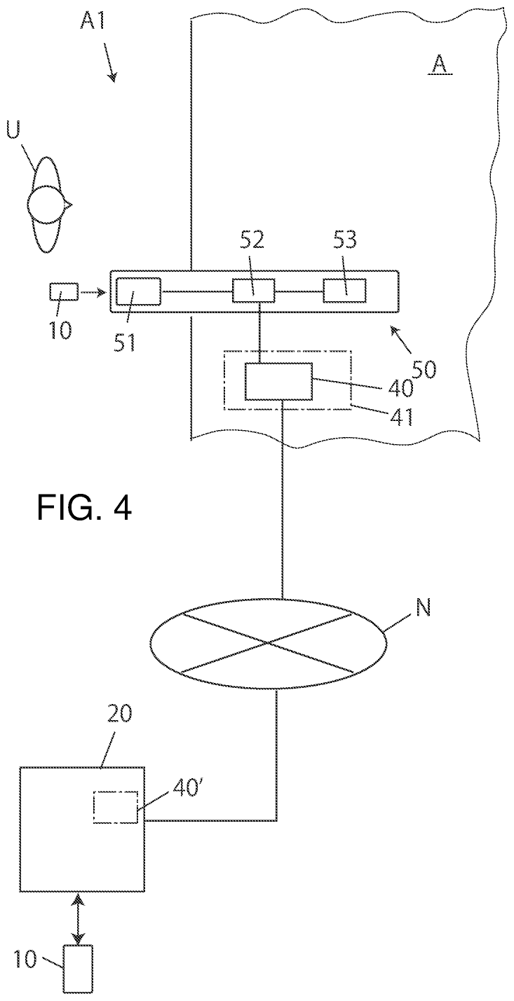

In FIGS. 2 and 4, the recording means 40 may be any device that can store certification information of not having a pathogen which proves that the traveler U does not have a particular pathogen and expiration time information of the certification information of not having the pathogen in relation to the traveler identification information (ID). For example, the recording means 40 may be a hard disk device of a personal computer 41 managed by an administrator of the gate apparatus 30 or the confirmation apparatus 50. In this case, it is preferable that the personal computer 41 managed by the administrator of the gate apparatus 30 or the confirmation apparatus 50 is connected to the aforementioned information recording apparatus 20 via a network N (including the Internet).

The recording means 40 may also be a hard disk device 40′ of a personal computer that is used as the information recording apparatus 20. In this case, the personal computer 41 managed by the administrator of the gate apparatus 30 or the confirmation apparatus 50 is connected to the information recording apparatus 20 via the network N.

The recording means 40 stores certification information of vaccination which proves that the traveler U has received a particular vaccine and expiration time information of the certification information of vaccination in relation to the traveler identification information, as required.

The confirmation apparatus 50 (see FIG. 3) may be any apparatus that can acquire as input certification information of not having a pathogen and expiration time information thereof from the recording medium 10 carried by the traveler U and confirm the certification information of not having the pathogen and expiration time thereof. The confirmation apparatus 50 may be installed at the entrance A1 of a site or area A (e.g., a medical institution such as a hospital) in which the spread of a particular pathogen by the traveler U should be prevented.

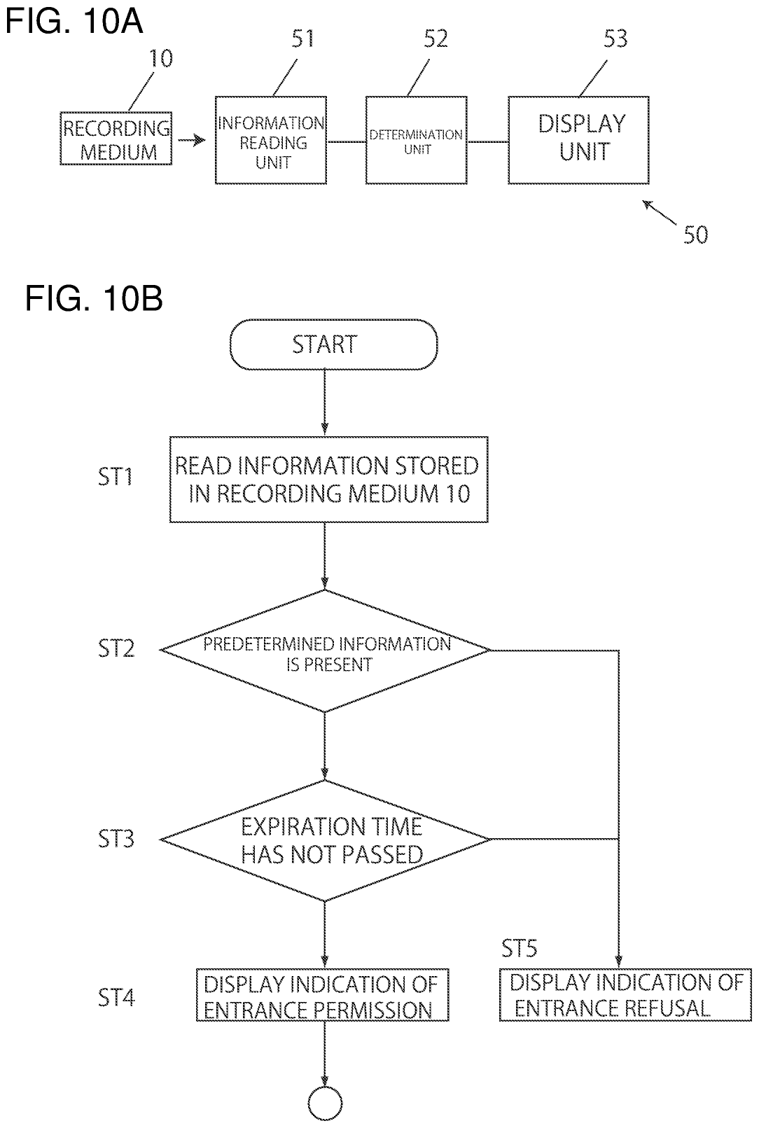

As shown in FIG. 10, the confirmation apparatus 50 may include an information reading unit 51 for reading information stored in the recording medium 10 carried by the traveler U, and a determination unit 52 that processes the information read by the information reading unit 51 from the recording medium 10, determines whether to allow the traveler U to enter the site or area A or not, and display the result of determination on a display unit 53.

The determination unit 52 operates as follows:

### <Step ST1>

Read information stored in the recording medium 10 carried by the traveler U.

### <Step ST2>

Determine the presence or absence of certification information of not having a particular pathogen for which entry control is implemented (a pathogen code and its corresponding certification information (“OK”)) and/or certification information of vaccination (a vaccine code and its corresponding certification information (“OK”)) and expiration time information thereof.

If the above information is present, the determination unit 52 proceeds to Step ST3. Otherwise, if the above information is absent, the determination unit 52 proceeds to Step STS.

### <Step ST3>

Determine whether or not expiration time of the above information has passed when the information is read in Step ST1.

If expiration time of the above information has not passed yet when the information is read in Step ST1, the determination unit 52 proceeds to Step ST4. Otherwise, the determination unit 52 proceeds to Step ST5.

### <Step ST4>

Display an indication that the traveler is granted entrance permission on the display unit 53.

### <Step ST5>

Display an indication that the traveler is refused entrance permission on the display unit 53.

Specific embodiments of the present invention have been described above. In the following, advantageous effects of the invention will be described.

The world is still under the threat of viruses.

Viruses are primarily transmitted by mosquitoes, birds or animals but infection with some viruses including the new coronavirus is spread by humans

With the globalization of the world economy during the late 20th and 21st centuries, the number of travelers has been increasing dramatically.

Anybody can be infected and spread an infection.

As an example of infection prevention measures, lockdown have some effect to prevent the spread of infection.

It is difficult to achieve infection prevention without restricting the movement of people for social and economic activities, for example, by banning or containing the movement of infected people or blocking infected people from outside.

These measures, however, have limitations.

How is it possible to reduce damage from current threats such as the new coronavirus and future threats with less restrictions on social activities? What is effective to contain a virus, prevent the spread of it, and treat it. It is said that vaccines for the new coronavirus will have been developed by the end of 2020. It is also said that clinical trials of therapeutic medicines for the new coronavirus infection will have completed at the end of 2020.

In the current situation in Japan, however, cities cannot be put into lockdown. Rather, a considerable number of people are still moving around and infection sources cannot be thoroughly contained whether they are small, middle, or large in scale.

In view of the above, the present invention provides a method of restricting the movement of people by transportation means effectively.

Today, people move by various kinds of transportation means such as airplane, train, ship, car, bicycle and foot. If the movement can be restricted, a virus is contained in a small area and the speed of the spread of the virus is reduced.

The point of the present invention is to prevent entrance (or exit).

According to the present invention, a key (a recording medium 10 such as a card) is required for entrance (or exit).

For example, in order to participate in an event bigger than a certain scale, a recording medium 10 such as a card is required as a certification of vaccination.

According to the present invention, only those who do not have a particular pathogen or have received a vaccine as described below can be proven to be clean by a recording medium 10 carried by them and allowed to enter a particular site or area A.

Examples of the particular site or area A include an area where boarding procedures are performed in an airport, a ticket gate area in a Shinkansen bullet train or some other train station, a baseball stadium such as Korakuen stadium, a concert venue, a soccer stadium, a rugby stadium, a swimming venue, a large sports venue such as a martial arts stadium, any kind of exhibition venue, any kind of concert venue, an entertainment facility such as a kabuki theater, an elementary school, a junior high school, a high school, a university, a vocational college, any kind of tutoring school, a traditional Japanese inn, a hotel, and any other site where a large number of people gather.

The spread of infection in big cities such as Tokyo, sightseeing areas such as Kyoto, or provincial cities having abundant tourism resources results in enormous economic damage.

To resume normal economic and social activities safely and quickly, it is required that people who do not have a pathogen or have received a vaccine can prove that they are clean from the pathogen or have been vaccinated against it.

The method according to the present invention may require much more extra time and effort as compared to the current prevention measures.

Taking such extra time and effort has great importance because it can not only protect yourself against infection but also protect other people's freedom, rights and property by preventing transmission to them.

According to the present invention, both entry and departure of overseas travelers can be prevented if they do not have certifications of appropriate vaccination for the actual situation of their destinations.

For overseas travel, every traveler has to have a passport.

This is an international rule. It is possible to use a passport as a recording medium 10, in which case, travelers are obliged to carry their recording medium 10.

Even within a country, it is possible to mandate the presentation of a recording medium 10 to access a site where a large number of people gather, for example, to attend a large meeting, concert, or sports event, or to take a train or an airplane.

This can enable prompt action against outbreaks of the new coronavirus or any other unexpected diseases and minimize economic or other damage caused by the outbreak. Wide use of the method of the present invention can be a practical option to the spread of disease not only in Japan but also worldwide.

Although an influenza epidemic occurs every winter, the rates of flu vaccination in the last few years are about 50%. It is proven that vaccination prevents about 60% of flu infection in Japan. Introduction of the method of the present invention can push up the rate of vaccination of young people who are likely to have larger spheres of life and therefore can decrease the rate of infection. Reduction in the number of people who get infected with influenza without vaccination and transmit it to others can reduce restrictions on social and economic activities such as cancellation of classes in school.

The method of the present invention can be a game changer that is able to prevent infection both to and from others. Storing information in a recording medium 10 may cause some privacy issues depending on what kinds of information are stored. In consideration of the public welfare and benefit, these issues are not critical.

It is important for each country to take measures against forgery of a recording medium 10 such as a card issued in the country.

The expiration time of the card is set to the end of the shortest validity period of validity periods of taken measures such as vaccination for the virus and a new card (recording medium 10) should be issued if forgery cannot be surely prevented when the information in the card is updated.

Preferably, a contact or non-contact IC card is used as a recording medium 10. In some countries, it may be difficult to issue such kind of cards. It is, however, preferable to adopt a contact or non-contact IC card as a recording medium 10 at least in the G20 countries.

It is preferable to adopt at least a card having an IC chip therein as a recording medium 10.

If a smartphone is used as a recording medium 10, a dedicated application in installed on the smartphone and then all the necessary information for the present invention is written to the smartphone. The smartphone can display the written information as required. All the information is written to the recording medium 10 and registered information can be displayed on the display screen. In a large sports event, spectators carry their smartphone for entry control, and therefore the method of the present invention can also be used seamlessly for such entry control.

The issuer of recording media 10 may be a medical institution or a governmental agency.

For example, a card can be issued and information can be written to the card by a (municipal) administrative agency with which the card holder's residency is registered, such as a city office, a town or village office, or a Japan Agricultural Cooperatives (JA) office.

Although this issuing process may be cumbersome, a recording medium 10 is expected to become commonly used because people are not allowed to enter a baseball stadium, a soccer stadium, a rugby stadium, or any other site for an event that attracts large crowds without their recording medium 10. As a result, the rate of vaccination may be raised.

Furthermore, when a patient is transported by an ambulance, if the patient presents a recording medium 10 to prove that the patient is vaccinated against the new coronavirus or any other infection, a hospital that is able to accept the patient can be found easily without the need to negotiate with a lot of hospitals.

In an office where many staff work, they can work without worry about infection if all the staff can prove that they are vaccinated.

That is, vaccination against viruses is the responsibility of each individual, and each individual is responsible for proving that the person is taking prevention measures against virus infection.

The recording medium 10 may store information on medications being taken (it is checked when an operation is performed because some medications inhibit blood clotting, for example), the blood type, and current and historical disease information (e.g., myocardial infarction in 1996, diabetes (2018), and CT images and ultrasound images taken for a stent insertion operation to treat the myocardial infarction). A password is set for the security of the personal information. This can reduce the physical and economic burden on the holder of the recording medium 10 if the holder is raced to a hospital due to injury or disease. When a smartphone is used as the recording medium 10, it has a sufficient storage capacity for the above-mentioned information.

Because most smartphones have a GPS function, it is possible to easily know the movement of a traveler U by utilizing the GPS function in connection with the functions of a recording medium 10.

Knowing the movement of infected people, action can be taken promptly to prevent the spread of infection. This can be particularly effective to prevent the spread of infectious diseases in the euro area since people can travel without their passport once they enter the area and thus it is difficult to know the movement of them when they travel by car or train.

Some embodiments of the present invention are described above but the invention is not limited to those embodiments. Rather, various modifications may be made without departing from the spirit and scope of the invention. For example,

In the above embodiments, the gate apparatus 30 is described by taking a flap-type gate apparatus as an example but the present invention can be applied to a gate system including a door-type gate apparatus or an interlock-type gate apparatus.

The present invention can also be applied to a gate apparatus having a configuration in which a card-type recording medium 10 is put into an insertion slot, an information reading process is performed on the recording medium 10 in the gate apparatus, and then the recording medium 10 is returned through a return slot.

It is possible to establish an organization that manages the traveler control systems described above (assume that the name of the organization is “Japan Infection Prevention Association”).

A person who has received a vaccine obtains a certification issued by a medical institution and sends it to the association along with identification such as a copy of the health insurance card or driving license and a photo of the person.

The association issues a recording medium 10 (assume that it is called an “infection prevention card”) based on those documents.

The association manages the information by using its own servers.

When the person is vaccinated again at another local medical institution, the medical institution rewrites the certification data by a card reader. Medical institutions that can rewrite certification data are determined on the recommendation of a local medical association.

For example, in the case of COVID-19, not a few people who test negative when they get an infection prevention card may get infected or reinfected afterwards. It is therefore better that certification information of vaccination and expiration time information of the certification information of vaccination certify immunity given by vaccination against COVID-19.

In this case, the expiration time of immunity is determined based on the kind and dose of a vaccine and updated with each vaccination so that the latest expiration time can be displayed at any time.

In the systems shown in FIGS. 2 and 4, the gate apparatus and the confirmation apparatus do not store necessary information. The gate apparatus and the confirmation apparatus transmit personal information stored in an IC chip to a server (assume that it is called an “infection prevention server”) to confirm the information as in the recent credit card systems. For a baseball stadium or a soccer stadium having a capacity of over fifty thousand spectators, it is advantageous to use touch-and-go-type gates that enable a large number of people to enter or exit through the gates in a short period of time by opening and closing in cooperation with servers as in the SUICA system. In contrast, for a small concert venue, in order to spare the cost of introducing new facilities, it is advantageous to develop a smartphone app that operates with a card-type recording medium issued by the infection prevention center and indicates whether the holder of the recording medium is infected with a pathogen or not, whether the holder has received a vaccine or not, and the expiration time of certification information. For a person who does not have a pathogen or who is immunized against the pathogen by vaccination, the edges of the display screen of the person's smartphone turn green, a photo of the person's face is enlarged on the screen for identification, and a sound is emitted simultaneously (e.g., a sound mimicking a cat going “meow” is emitted). A person who has a pathogen or who has not been immunized against the pathogen can be easily distinguished by the display screen of the person's smartphone turning red and the smartphone emitting a sound “bowwow.”

Even in a case there is no smartphone, confirmation can be performed with identification using an image and a red or green indication when the card is inserted in a card reader that is interlocked with a personal computer or a pad in a similar manner with AirPAY that is introduced even in small eating places.

This infection prevention card can be effectively used for, for example, foreign tourists, a customs and a quarantine system in an airport.

Overseas tourists to an area where prevention measures are required against a pathogen receive a vaccine to prevent infection and get a certification of the vaccination stored in their card, and prove the vaccination by the card when they depart for and return from the area.

For travel within Japan, the system can be introduced when people take an airplane, Shinkansen bullet train, ship, or any other long-distance transportation to protect public health.

### REFERENCE SIGNS LIST

10 Recording medium

20 Information recording apparatus

30 Gate apparatus

1. A traveler control system comprising:
a recording medium carried by a traveler, the recording medium configured to store certification information of not having a pathogen which proves that the traveler does not have a particular pathogen and expiration time information of the certification information of not having the pathogen;
an information recording apparatus managed by an administrator of certification information of not having the pathogen who has authority to issue the certification information of not having the pathogen and the expiration time information, the information recording apparatus configured to store the certification information of not having the pathogen and the expiration time information of the certification information of not having the pathogen in the recording medium; and
a gate apparatus configured to, when the traveler is passing the gate apparatus, acquire as input the certification information of not having the pathogen and the expiration time information of the certification information of not having the pathogen from the recording medium carried by the traveler, allow the traveler to pass the gate apparatus if presence of the certification information of not having the pathogen is confirmed and expiration time indicated by the expiration time information of the certification information of not having the pathogen has not passed yet when the certification information of not having the pathogen or the expiration time information of the certification information of not having the pathogen is input, and prevent the traveler from passing the gate apparatus if presence of the certification information of not having the pathogen is not confirmed or expiration time indicated by the expiration time information of the certification information of not having the pathogen has already passed when the information is input.

2. A traveler control system comprising:
a recording medium carried by a traveler, the recording medium configured to store certification information of vaccination which proves that the traveler has received a particular vaccine and expiration time information of the certification information of vaccination;
an information recording apparatus managed by an administrator of certification information of vaccination who has authority to issue the certification information of vaccination and the expiration time information, the information recording apparatus configured to store the certification information of vaccination and the expiration time information of the certification information of vaccination in the recording medium; and
a gate apparatus configured to, when the traveler is passing the gate apparatus, acquire as input the certification information of vaccination and the expiration time information of the certification information of vaccination from the recording medium carried by the traveler, allow the traveler to pass the gate apparatus if presence of the certification information of vaccination is confirmed and expiration time indicated by the expiration time information of the certification information of vaccination has not passed yet when the certification information of vaccination or the expiration time information of the certification information of vaccination is input, and prevent the traveler from passing the gate apparatus if presence of the certification information of vaccination is not confirmed or expiration time indicated by the expiration time information of the certification information of vaccination has already passed when the information is input.

3. A traveler control system comprising:
a recording medium carried by a traveler, the recording medium configured to store traveler identification information that identifies the traveler;
recording means configured to store, in relation to the traveler identification information, certification information of not having a pathogen which proves that the traveler does not have a particular pathogen and expiration time information of the certification information of not having the pathogen;
an information recording apparatus managed by an administrator of certification information of not having the pathogen who has authority to issue the certification information of not having the pathogen and the expiration time information, the information recording apparatus configured to store the certification information of not having the pathogen and the expiration time information of the certification information of not having the pathogen in the recording means in relation to the traveler identification information; and
a gate apparatus configured to, when the traveler is passing the gate apparatus, acquire as input the traveler identification information from the recording medium carried by the traveler, check the traveler identification information against the certification information of not having the pathogen and the expiration time information of the certification information of not having the pathogen that correspond to the traveler identification information and are stored in the recording means, allow the traveler to pass the gate apparatus if presence of the certification information of not having the pathogen is confirmed and expiration time indicated by the expiration time information of the certification information of not having the pathogen has not passed yet when the traveler identification information is input, and prevent the traveler from passing the gate apparatus if presence of the certification information of not having the pathogen is not confirmed or expiration time indicated by the expiration time information of the certification information of not having the pathogen has already passed when the traveler identification information is input.

4. A traveler control system comprising:
a recording medium carried by a traveler, the recording medium configured to store traveler identification information that identifies the traveler;
recording means configured to store, in relation to the traveler identification information, certification information of vaccination which proves that the traveler has received a particular vaccine and expiration time information of the certification information of vaccination;
an information recording apparatus managed by an administrator of certification information of vaccination who has authority to issue the certification information of vaccination and the expiration time information, the information recording apparatus configured to store the certification information of vaccination and the expiration time information of the certification information of vaccination in the recording means in relation to the traveler identification information; and
a gate apparatus configured to, when the traveler is passing the gate apparatus, acquire as input the traveler identification information from the recording medium carried by the traveler, check the traveler identification information against the certification information of vaccination and the expiration time information of the certification information of vaccination that correspond to the traveler identification information and are stored in the recording means, allow the traveler to pass the gate apparatus if presence of the certification information of vaccination is confirmed and expiration time indicated by the expiration time information of the certification information of vaccination has not passed yet when the traveler identification information is input, and prevent the traveler from passing the gate apparatus if presence of the certification information of vaccination is not confirmed or expiration time indicated by the expiration time information of the certification information of vaccination has already passed when the traveler identification information is input.

5. The traveler control system according to claim 1, wherein the recording medium is a passport.

6. The traveler control system according to claim 2, wherein the recording medium is a passport.

7. The traveler control system according to claim 3, wherein the recording medium is a passport.

8. The traveler control system according to claim 4, wherein the recording medium is a passport.
